(19) United States
(12) Patent Application Publication
(10) Pub. No.: US 2023/0050341 A1
(43) Pub. Date: Feb. 16, 2023

(54) Luggage Scale Device

(71) Applicant: Broc Vierzba, East Bethel, MN (US)

(72) Inventor: Broc Vierzba, East Bethel, MN (US)

(21) Appl. No.: 17/881,750

(22) Filed: Aug. 5, 2022

Related U.S. Application Data
(60) Provisional application No. 63/231,312, filed on Aug. 10, 2021.

(51) Int. Cl. G01G 19/18; G01G 21/28; G01G 3/14

(52) U.S. Cl. CPC G01G 19/18; G01G 21/283; G01G 3/1402

(57) ABSTRACT

The present invention relates to a luggage scale device. A housing of the device can be attached to a wall via a fastener, wherein a weighing member can then be extended perpendicular to the housing. The strain gauge load cell is positioned on the member and allows luggage to be weighed via placing a strap of the luggage on the member such that the device suspends the luggage above the ground. The weight of the luggage is then displayed via a display on the housing.

### CROSS-REFERENCE TO RELATED APPLICATION

The present application claims priority to, and the benefit of, U.S. Provisional Application No. 63/231,312, which was filed on Aug. 10, 2021, and is incorporated herein by reference in its entirety.

### FIELD OF THE INVENTION

The present invention relates generally to the field of weight scales. More specifically, the present invention relates to a luggage scale device. A housing of the device can be attached to a wall via a fastener, wherein a weighing member can then be extended perpendicular to the housing. The strain gauge load cell is positioned on the member and allows luggage to be weighed via placing a strap of the luggage on the member such that the device suspends the luggage above the ground. The weight of the luggage is then displayed via a display on the housing. Accordingly, the present disclosure makes specific reference thereto. Nonetheless, it is to be appreciated that aspects of the present invention are also equally applicable to other like applications, devices, and methods of manufacture.

### BACKGROUND

Luggage is essential while traveling. However, luggage is typically subject to strict weight limits. If luggage weighs more than the permitted weight, a traveling individual may incur a significant fee and/or have to remove items from the luggage to meet the weight requirement. This is undesirable and may be embarrassing for individuals. As a result, individuals may weigh their bags before leaving for the airport. However, traveling individuals may not always have access to scale before traveling to the airport. As such, many traveling individuals do not have a weigh to conveniently weigh their luggage before traveling to an airport.

Therefore, there exists a long-felt need in the art for a device that prevents a user from arriving at an airport with overweight luggage. There also exists a long-felt need in the art for a luggage scale device that can be used to weigh luggage. In addition, there exists a long-felt need in the art for a luggage scale device that is easily transportable and can be used anywhere.

The subject matter disclosed and claimed herein, in one embodiment thereof, comprises a luggage scale device. The device is primarily comprised of a housing with at least one weighing member, at least one display, and at least one strain gauge load cell. The housing can be attached to a wall via a fastener, wherein the weighing member can then be extended perpendicular to the housing. The strain gauge load cell is positioned on the member and allows luggage to be weighed via placing a strap of the luggage on the member such that the device suspends the luggage above the ground. The weight of the luggage is then displayed via a display on the housing.

In this manner, the luggage scale device of the present invention accomplishes all of the foregoing objectives and provides a device that prevents a user from arriving at an airport with overweight luggage. To do so, the device allows a user to conveniently weigh their luggage. In addition, the device is easily transportable and can be used anywhere, which is extremely advantageous for travelers.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a luggage scale device. The device is primarily comprised of a housing with at least one weighing member, at least one display, and at least one strain gauge load cell. In the preferred embodiment, the housing has a front wall, a plurality of side walls, and a rear wall that form a generally rectangular housing. The front wall of the housing is comprised of a weighing member that extends outwards from the front wall via at least one hinge such that the weighing member is perpendicular to the front wall.

The rear surface of the weighing member is further comprised of at least one strain gauge load cell. The cell is comprised of at least one strain gauge, at least one load cell sensor (i.e., force transducer), at least one converter, and at least one microchip.

To use the device, a user first secures the rear wall of the housing to a wall via at least one fastener that allows the rear surface to fasten to the wall. The user can then position the weighing member perpendicular to the front wall. Then, the strap or straps of a piece of luggage, bag, or other item can be placed on the weighing member such that the strap contacts the strain gauge load cell and is suspended off the ground via the weighing member.

The load cell sensor has an electric charge such that as the sensor is pressed downward and once the strap is placed on the sensor, the electrical resistance of the sensor will change. The strain gauge then converts this change into an electric signal that runs through at least one analog to digital converter which is in electrical communication with at least one microchip. The microchip is in electrical communication with at least one display such that the weight of the luggage is displayed in numerical form via at least one indicia. The load cell and display are powered by and in electrical communication with at least one battery. The battery may be recharged by at least one USB port of any USB type known in the art.

Accordingly, the luggage scale device of the present invention is particularly advantageous as it provides a device that prevents a user from arriving at an airport with overweight luggage by allowing a user to conveniently weigh their luggage. In addition, the device is easily transportable and can be used anywhere, which is extremely advantageous for travelers. In this manner, the luggage scale device provides a novel solution to on-the-go luggage weighing.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a luggage scale device of the present invention while attached to a wall and in a closed position in accordance with the disclosed architecture;

FIG. 2 illustrates a perspective view of one potential embodiment of a luggage scale device of the present invention while attached to a wall and in an opened position in accordance with the disclosed architecture; and

FIG. 3 illustrates a perspective view of one potential embodiment of a luggage scale device of the present invention while attached to a wall and in an opened position while weighing luggage in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that prevents a user from arriving at an airport with overweight luggage. There also exists a long-felt need in the art for a luggage scale device that can be used to weigh luggage. In addition, there exists a long-felt need in the art for a luggage scale device that is easily transportable and can be used anywhere.

The present invention, in one exemplary embodiment, is comprised of a luggage scale device. The device is primarily comprised of a housing with at least one weighing member, at least one display, and at least one strain gauge load cell. In the preferred embodiment, the housing has a front wall, a plurality of side walls, and a rear wall that form a generally rectangular housing. The front wall is comprised of a weighing member that extends outward from the front wall via at least one hinge such that the weighing member is perpendicular to the front wall. The rear surface of the weighing member is further comprised of at least one strain gauge load cell. The cell is comprised of at least one strain gauge, at least one load cell sensor (i.e., force transducer), at least one converter, and at least one microchip.

To use the device, a user first secures the rear wall of the housing to a wall via at least one fastener that allows the rear surface to fasten to the wall. The user can then position the weighing member perpendicular to the front wall. Then, the strap or straps of a piece of luggage, bag, or other item can be placed on the weighing member such that the strap contacts the strain gauge load cell and is suspended off the ground via the weighing member.

The load cell sensor has an electric charge such that as the sensor is pressed downward and once the strap is placed on the sensor, the electrical resistance of the sensor will change. The strain gauge then converts this change into an electric signal that runs through at least one analog to digital converter which is in electrical communication with at least one microchip. The microchip is in electrical communication with at least one display such that the weight of the luggage is displayed in numerical form via at least one indicia. The load cell and display are powered by and in electrical communication with at least one battery. The battery may be recharged by at least one USB port of any USB type known in the art.

Accordingly, the luggage scale device of the present invention is particularly advantageous as it provides a device that prevents a user from arriving at an airport with overweight luggage by allowing a user to conveniently weigh their luggage. In addition, the device is easily transportable and can be used anywhere, which is extremely advantageous for travelers. In this manner, the luggage scale device provides a novel solution to on-the-go luggage weighing.

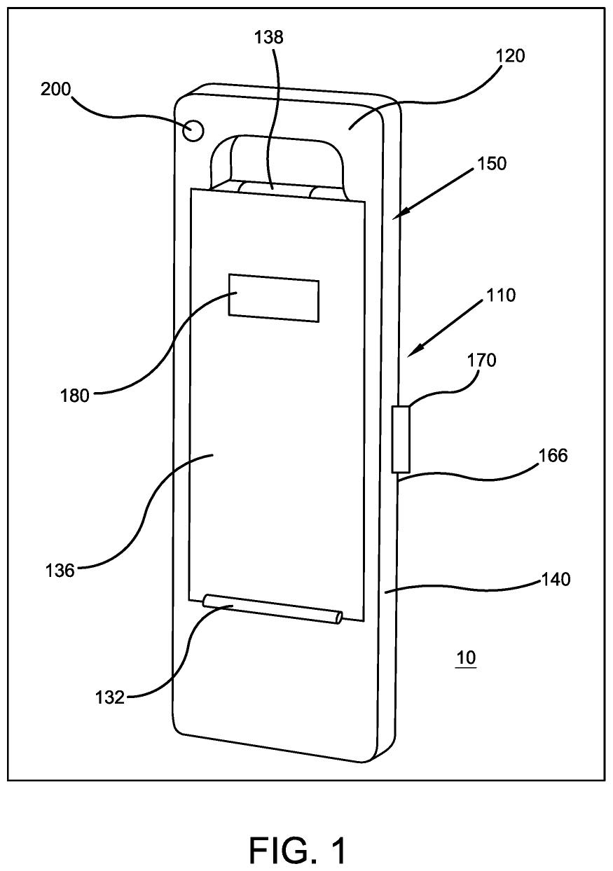

Referring initially to the drawings, FIG. 1 illustrates a perspective view of one potential embodiment of a luggage scale device 100 of the present invention while attached to a wall and in a closed position in accordance with the disclosed architecture. The device 100 is primarily comprised of a housing 110 with at least one weighing member 130, at least one display 162, and at least one strain gauge load cell 300. The device 100 and all components are preferably made from a rigid plastic such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc., and/or a durable metal such as, but not limited to, aluminum or stainless steel. In the preferred embodiment, the housing 110 has a front wall 120, a plurality of side walls 140, and a rear wall 150 that form a generally rectangular housing 110. However, the housing 110 may be any shape known in the art such as, but not limited to, square, circular, polygonal, etc.

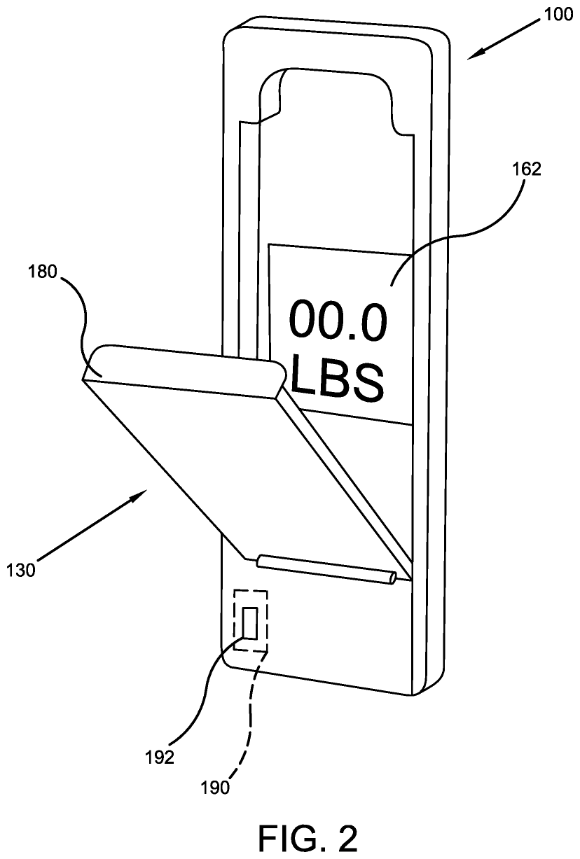

The front wall 120 of the housing 110 is comprised of a weighing member 130. The weighing member 130 extends outward from the front wall 120 via at least one hinge 132 (as seen in FIG. 2) such that the weighing member 130 is perpendicular to the front wall 120. In various embodiments, the hinge 132 may be any hinge type known in the art such as, but not limited to, an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc.

In one embodiment, the rear surface 134 and/or front surface 136 of the weighing member 130 may have at least one fastener 138. The fastener 138 allows the weighing member 130 to remain secure (i.e., locked) to the front wall 120 and/or the front surface 160 of the rear wall 150 when the device 100 is not in use. There may also be a reciprocating fastener 138 of the same type located on the front wall 120 and/or the front surface 160 of the rear wall 150. The fastener 138 may be any fastener type known in the art such as, but not limited to, hook and loop, adhesive, magnetic, snap-button, tongue and groove, latch, etc.

The weighing member 130 is preferably rectangular in shape but may be any shape known in the art such as, but not limited to, a hook-like shape in various embodiments. The rear surface 134 of the weighing member 130 is further comprised of at least one strain gauge load cell 300. The cell 300 is comprised of at least one strain gauge 130, at least one load cell sensor 320 (i.e., force transducer), at least one converter 300, and at least one microchip 340.

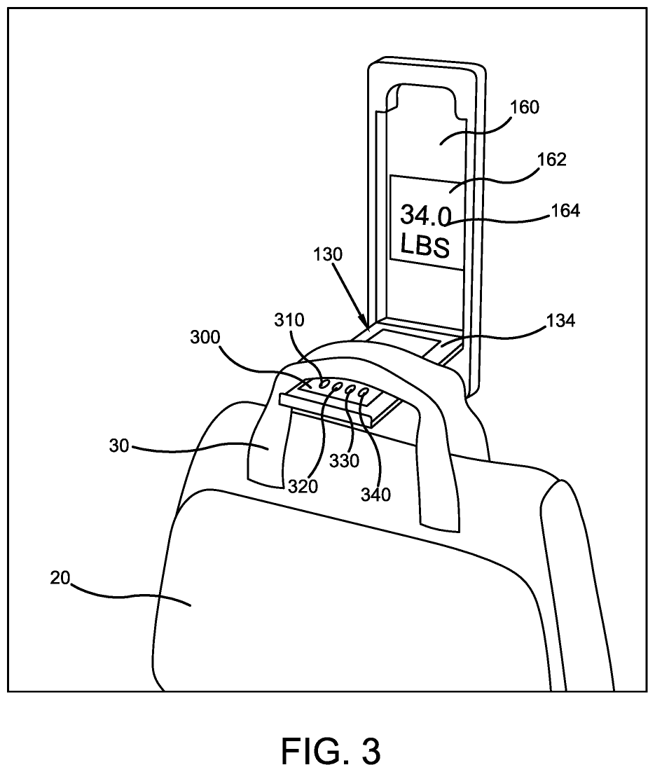

FIG. 3 illustrates a perspective view of one potential embodiment of a luggage scale device 100 of the present invention while attached to a wall and in an opened position while weighing luggage in accordance with the disclosed architecture. To use the device 100, a user first secures the rear wall 150 of the housing 110 to a wall 10. The rear surface 166 of the rear wall 150 has at least one fastener 190 that allows rear surface 166 to fasten to the wall 10. The fastener 190 may be any fastener known in the art such as, but not limited to, adhesive, magnetic, suction cup, etc. The user can then position the weighing member 130 perpendicular to the front wall 120. The weighing member 130 may further be comprised of at least one handle 180 to aid in the repositioning of the weighing member 130 during use. Then, the strap 30 or straps 30 of a piece of luggage 20, bag, or other item can be placed on the weighing member 130 such that the strap 30 contacts the strain gauge load cell 300 and is suspended off the ground via the weighing member 130. The device 100 may be used to weigh luggage 20 but may also be used to weigh various items that can be placed within a bag or other hanging object. At least one button 200 on the housing 110 may allow a user to tare the strain gauge 310 to account for the extra weight of a bag which various items may be placed in.

The load cell sensor 320 has an electric charge. As the sensor 320 is pressed downward and once the strap 30 is placed on the sensor 320, the electrical resistance of the sensor 320 will change. The strain gauge 310 then converts this change into an electric signal. The electric signal runs through at least one analog to digital converter 330 which is in electrical communication with at least one microchip 340. The microchip 340 is in electrical communication with at least one display 162 such that the weight of the luggage 20 is displayed in numerical form via at least one indicia 164. The display 162 may be positioned anywhere on the housing 110 but is preferably positioned on the front surface 160 of the rear wall 150. In various embodiments, the display 162 may display the weight of the luggage 20 in a plurality of weight units such as, but not limited to, pounds, ounces, grams, kilograms, etc., that can be selected via the button 200. It is preferred that the device 100 have a minimum weight of 1 gram (or equivalent other unit). The display 162 may be any display screen known in the art such as, but not limited to, a touch screen, an LCD screen, an OLED screen, an ELD screen, an LED backlit LCD screen, an LED screen, a PDP screen, etc.

The load cell 300 and display 162 are powered by and in electrical communication with at least one battery 190. The battery 190 may be a disposable battery 190 or a rechargeable battery 190 in the form of an alkaline, nickel-cadmium, nickel-metal hydride battery 190, etc., such as any 3V-12 volts DC battery 190 or other conventional battery 190 such as A, AA, AAA, etc., that supplies power to the device 100. Throughout this specification the terms “battery” and “batteries” may be used interchangeably to refer to one or more wet or dry cells or batteries 190 of cells in which chemical energy is converted into electricity and used as a source of DC power. References to recharging or replacing batteries 190 may refer to recharging or replacing individual cells, individual batteries 190 of cells, or a package of multiple battery cells as is appropriate for any given battery 190 technology that may be used. Additionally, the battery 190 may be recharged by at least one USB port 192 of any USB type known in the art.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “luggage scale device” and “device” are interchangeable and refer to the luggage scale device 100 of the present invention.

Notwithstanding the foregoing, the luggage scale device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the luggage scale device 100 as shown in the FIGS. are for illustrative purposes only, and that many other sizes and shapes of the luggage scale device 100 are well within the scope of the present disclosure. Although the dimensions of the luggage scale device 100 are important design parameters for user convenience, the luggage scale device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A luggage scale device comprising:
a housing;
a hinge positioned on the housing;
a weighing member attached to the hinge;
a display;
a strain gauge load cell;
a battery; and
a fastener.

2. The luggage scale device of claim 1, wherein the fastener is positioned on a rear surface of a rear wall of the housing.

3. The luggage scale device of claim 2, wherein the fastener is an adhesive fastener, a magnetic fastener, or a suction cup fastener.

4. The luggage scale device of claim 1, wherein the strain gauge load cell is positioned on the weighing member.

5. The luggage scale device of claim 4, wherein the display displays a weight value measured by the strain gauge load cell.

6. A luggage scale device comprising:
a housing;
a hinge positioned on the housing;
a weighing member attached to the hinge;
a display;
a strain gauge load cell comprised of a strain gauge, a load cell sensor, a converter, and a microchip;
a battery; and
a fastener.

7. The luggage scale device of claim 6, wherein the display is positioned on a front surface of a rear wall of the housing.

8. The luggage scale device of claim 6, wherein the display is a touch screen, an LCD screen, an OLED screen, an ELD screen, an LED backlit LCD screen, an LED screen, or a PDP screen.

9. A luggage scale device comprising:
a housing;
a hinge positioned on a front wall of the housing;
a weighing member positioned on the front wall of the housing, the weighing member attached to the hinge;
a display;
a strain gauge load cell comprised of a strain gauge, a load cell sensor, a converter, and a microchip;
a battery;
a button;
a first fastener; and
a second fastener.

10. The luggage scale device of claim 9, wherein the weighing member is comprised of a handle.

11. The luggage scale device of claim 9 further comprised of a USB port.

12. The luggage scale device of claim 9, wherein the load cell sensor has an electric charge.

13. The luggage scale device of claim 12, wherein the strain gauge converts a change in the electric charge to an analog electric signal.

14. The luggage scale device of claim 13, wherein the analog electric signal is run through the converter to convert the analog electric signal to a digital signal.

15. The luggage scale device of claim 14, wherein the digital signal is communicated to the microchip.

16. The luggage scale device of claim 15, wherein the microchip communicates the digital signal to the display.

17. The luggage scale device of claim 16, wherein the display displays the digital signal as a weight.

18. The luggage scale device of claim 9, wherein the first fastener is positioned on a rear surface of a rear wall of the housing.

19. The luggage scale device of claim 9, wherein the second fastener is positioned on the weighing member.

20. The luggage scale device of claim 19, wherein the second fastener secures the weighing member to a front wall of the housing.
